(19) United States
(12) Patent Application Publication
(10) Pub. No.: US 2015/0143236 A1
(43) Pub. Date: May 21, 2015

(54) GENERATING PHOTO ALBUMS FROM UNSORTED COLLECTIONS OF IMAGES

(71) Applicant: Disney Enterprises, Inc., Burbank, CA (US)

(72) Inventors: Jose Rafael Tena Rodriguez, Pittsburgh, PA (US); Fereshteh Sadeghi, Seattle, WA (US); Leonid Sigal, Pittsburgh, PA (US); Tinghui Zhou, Berkeley, CA (US)

(73) Assignee: Disney Enterprises, Inc., Burbank, CA (US)

(21) Appl. No.: 14/084,348

(22) Filed: Nov. 19, 2013

(51) Int. Cl. G06F 17/21

(52) U.S. Cl. CPC G06F 17/212
USPC 715/273

(57) ABSTRACT

Techniques for generating a photo album are described. Embodiments analyze a plurality of photo albums to determine photo album characteristics, where each of the plurality of photo albums comprises a respective plurality of digital photographs arranged in a respective order. Here, the plurality of photo albums relate to one or more digital photograph collections. Additionally, a digital photograph collection is processed to determine characteristics of each digital photograph within the digital photograph collection. Embodiments also generate a photo album using digital photographs from the digital photograph collection, based on the determined photograph album characteristics, where the generated photo album comprises a second plurality of digital photographs arranged in a determined order.

### BACKGROUND

1. Field of the Invention

Embodiments generally relate to the field of digital image processing, and more particularly to techniques for ordering and arranging digital photographs based on preferences determined by analyzing previously created photo albums.

2. Description of the Related Art

Digital imaging technology has made it possible for users to inexpensively create customized products such as photo greeting cards, framed prints and albums. Moreover, even existing traditional paper print may be scanned into a digital format and used to create a new print product. A number of commercially available software products exist that provide custom printing services to be used for printing on a home printer. Additionally, photo kiosks may provide similar services where users may scan, after and print digital photographs, and may also be used to create printed products such as greeting cards that include one or more digital photographs. Such products may provide various templates for use in creating the print products, and may also provide a vast selection of colors and designs for use in creating backgrounds, borders, etc. on the printed product. Such products may also allow for the insertion of text into the printed product, with various options with respect to fonts, sizes and colors of the text.

In addition to using photographs to create printed products, albuming software products exist that allow a user to create a photo album from multiple photographs. These photo albums can enable users to store and arrange their photographs in a creative way. For example, a user could create a photo album from a set of photographs taken on a particular vacation, and could arrange the photographs in a photo album such that the album tells a visual narrative of the particular vacation. Such albuming products may also provide various templates for the layout of the photo album, and can also allow the users to select various backgrounds and borders for the photo album. Some albuming software can also allow the user to insert music or audio content with pages of the photo album.

Generally, the generation of a quality photo album can be a time-consuming and manual process, as the user must search for suitable images to include in the photo album and may experiment with various layout options and combinations of photographs until a visually pleasing combination is found. While these albuming applications may provide users with a wide variety of options that enable the users to create customized photo albums, such options may make the task of album creation increasingly difficult for less sophisticated users. Moreover, such customization options may make the task of album creation more time consuming, as the user may experiment with various permutations of options in an attempt to create an effective presentation of their photographs. In some circumstances, users may get tired of exploring all possible combinations and may end up settling on a design which does not meet all theft criteria, resulting in user dissatisfaction.

### SUMMARY

Embodiments provide a method, computer-readable medium and system for generating photo albums. The method, computer-readable medium and system include analyzing a plurality of photo albums to determine photo album characteristics. Each of the plurality of photo albums generally includes a respective plurality of digital photographs arranged in a respective order. Additionally, each of the plurality of photo albums relate to one or more digital photograph collections. The method, computer-readable medium and system further include processing a digital photograph collection to determine characteristics of each digital photograph within the digital photograph collection. The method, computer-readable medium and system also include generating a photo album using digital photographs from the digital photograph collection, based on the determined photograph album characteristics, where the generated photo album comprises a second plurality of digital photographs arranged in a determined order.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system configured with a photo album creation component, according to one embodiment described herein.

FIG. 2 is an exemplary photo album, according to one embodiment described herein.

FIG. 3 is a block diagram illustrating a system configured with a photo album creation component, according to one embodiment described herein.

FIG. 4 is a flow diagram illustrating a method for generating a photo album, according to one embodiment described herein.

FIG. 5 is a flow diagram illustrating a method for generating a photo album, according to one embodiment described herein.

FIG. 6 is a block diagram illustrating a system configured with a photo album creation component, according to one embodiment described herein.

### DETAILED DESCRIPTION

As discussed above, digital photo album generation is largely a manual and time-consuming process. Moreover, while album generation products may provide various options that enable a user to generate a highly customized photo album, such a plethora of options may also make the process of photo album generation more difficult and time-consuming. This is particularly true with less sophisticated users. Additionally, album generation products may be configured to automatically produce a photocollage using image recognition techniques. In certain products, layout selection and page design for the photocollage are performed automatically based on a user profile containing the user's color preferences, layout preferences and design considerations. Even in such products, however, the user may still need to manually create the user profile.

As such, embodiments provide techniques for automated photo album creation from an unordered photo collection. Of note, as used herein, the terms photo and photograph are used interchangeably. Embodiments may receive the unordered photo collection that contains a plurality of digital photographs taken using a camera device. For example, the photo collection could include photographs taken during a vacation to a theme park, and the photos could be retrieved from a digital camera's memory card. Embodiments could process the photos within the unordered photo collection in order to determine characteristics of each photograph within the collection. Embodiments could further analyze a plurality of existing photo albums in order to determine preferred photo album characteristics. For instance, embodiments could process photo albums previously created by a particular user, in order to learn the particular user's individual preferences for photo album generation. Embodiments could then generate a photo album by arranging digital photographs selected from the unordered photo collection, based on the determined photograph characteristics and the preferred photo album characteristics. Advantageously, doing so provides an automated way to generate a photo album from a collection of unordered photographs, while tailoring the generated photo album to a particular set of preferences (e.g., the particular user's individual preferences in the above example).

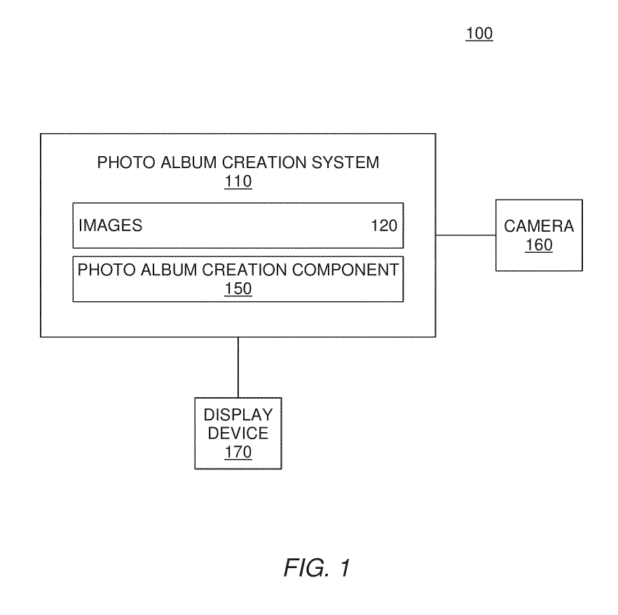

FIG. 1 is a block diagram illustrating a system configured with a photo album creation component, according to one embodiment described herein. As shown, the system 100 includes a photo album creation system 110 coupled to a camera 160 and a display device 170. The photo album creation system 110 includes a plurality of images 120 and a photo album creation component 150. Here, the images 120 represent an unordered collection of photographs, e.g., digital photographs from a family vacation downloaded from a digital camera's memory card. Generally, the photo album creation component 150 is configured to generate a photo album by selecting photographs from images 120 and arranging the selected photographs in a determined order. Here, the photo album creation component 150 may generate the photo album according to a set of preferences learned by processing one or more previously created photo albums. For example, the photo album creation component 150 could be preconfigured with the preferences information, based on the processing of a random sampling of photo albums having favorable reviews. As another example, the photo album creation component 150 could determine the preferences of a particular user by processing photo albums previously created by the particular user.

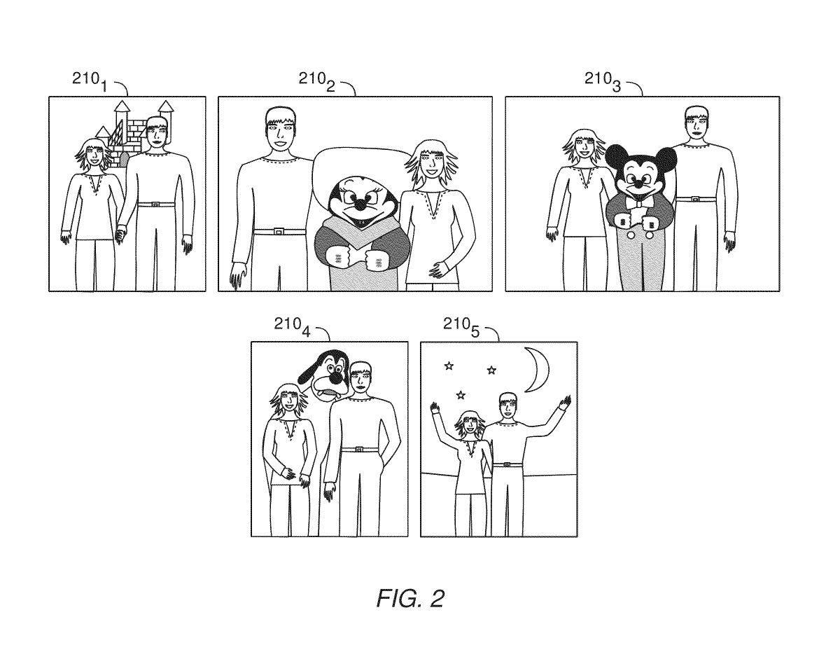

FIG. 2 is an exemplary photo album, according to one embodiment described herein. As shown, the photo album 200 includes photographs 210₁₋₅, which were selected from an unordered collection of images taken on a family vacation. Of note, the photographs 210₁₋₅ within the photo album 200 may be of different sizes (e.g., different resolutions) and different orientations (e.g., portrait or landscape orientation). Additionally, the photographs 210₁₋₅ are arranged in a particular order, such that the photograph 210₁ has an initial position within the photo album 200, the photograph 210₅ has a final position within the photo album 200, and the photographs 210₂₋₄ have central positions within the photo album 200.

Here, the photo album creation component 150 could have analyzed a plurality of photo albums previously created by a particular user in order to determine photo album preferences of the particular user. Such preferences could include, for example, characteristics of photographs the particular user selected for the initial position within the photo album, as well as characteristics of photographs selected for the central and final positions within the photo album. The photo album creation component 150 could then process an unordered collection of photographs taken on the family vacation, and could select the photographs 210₁₋₅ as the photographs within the unordered collection of photographs that best match the determined preferences. Advantageously, doing so provides an automated way of generating a photo album from a collection of photographs, where the photo album is optimized for a user's individual preferences.

In one embodiment, the photo album creation component 150 is configured to generate a photo album that includes a selection of photographs that summarize the collection of photographs. In another embodiment, the photo album creation component 150 could generate a photo album that describes a predefined storyline. For instance, the photo album creation component 150 could determine that the image collection relates to a particular attraction or destination (e.g., based on metadata associated with the photographs, such as GPS data, time and data information, camera parameters, etc.), and in response, could select a predefined storyline associated with the particular attraction or destination (e.g., by querying a remote server with an indication of the attraction or destination to retrieve the predefined storyline). For example, the collection of photographs could include photographs taken at a national park, and the photo album creation component 150 could download a predefined storyline associated with the national park. The photo album creation component 150 could then generate a photo album according to this storyline, by selecting and ordering photographs taken at the national park and consistent with the storyline.

In one embodiment, the photo album creation component 150 is configured to generate clusters of images in order to prevent substantially similar images from appearing within the same photo album. For instance, the photo album creation component 150 could sort the collection of photographs into a number of clusters, where each cluster includes images that are substantially similar to one another. For example, the collection could include 5 different photographs taken of a family in front of a particular attraction on a vacation. Such duplicative photographs are often found in image collections, as they provide redundancy in case one of the photographs is of poor quality. Generally, any number of different techniques may be used to determine the similarity between the photographs.

The photo album creation component 150 could then generate an ordered selection of the clusters for inclusion in the photo album. For instance, the photo album creation component 150 could select the clusters using substantially the same techniques used for selecting individual photographs for selecting and ordering photographs within the photo album. The photo album creation component 150 could then determine a measure of quality for each of the images in each of the selected clusters, and could determine a highest quality image within each of the selected clusters. The photo album creation component 150 could then generate the photo album using the highest quality images from each of the clusters, in the order determined for the clusters. Advantageously, doing so ensures that the photo album will not include multiple instances of duplicative or substantially similar images.

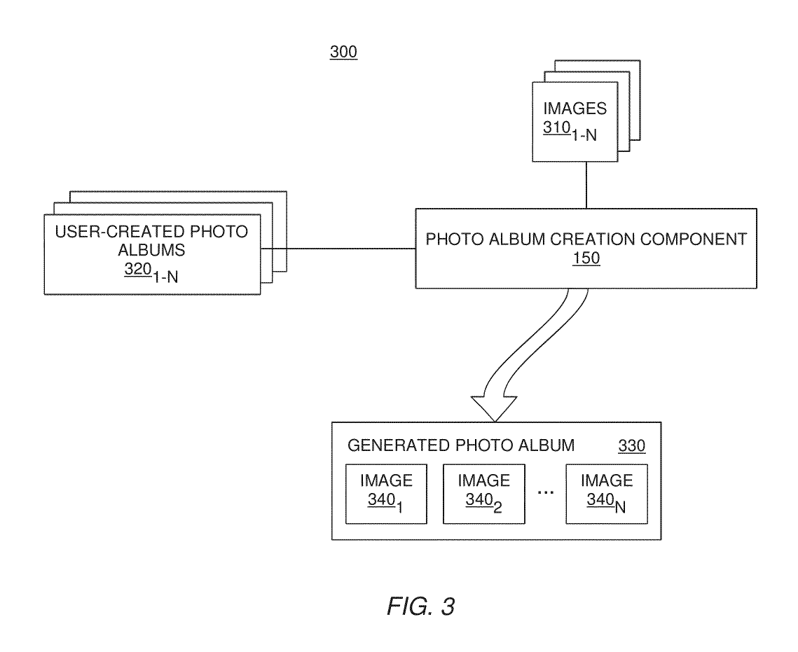

FIG. 3 is a block diagram illustrating a system configured with a photo album creation component, according to one embodiment described herein. As shown, the system 300 includes a photo album creation component 150, a plurality of user-created photo albums 320_{1-N}, an unordered collection of images 310_{1-N}, and a generated photo album 330. Here, the photo album creation component 150 has generated the photo album 330, which contains an ordered plurality of images 340_{1-N}, by selecting a subset of photographs from the images 310_{1-N}. For example, the photo album creation component 150 could process the user-created photo albums 320_{1-N} and could determine characteristics of photographs appearing at initial, final and central positions within the user-created photo albums 320_{1-N}. The photo album creation component 150 could further analyze each of the images 310_{1-N} to determine which of the images 310_{1-N} best match the determined characteristics of photographs appearing at the initial, final and central positions within the albums 320_{1-N}. The photo album creation component 150 could then select the photographs from images 310_{1-N} that best match these positions, and could insert the selected photographs into the photo album 330 in the corresponding order (as represented by the images 340_{1-N}).

In one embodiment, the photo album creation component 150 enables a user to edit the generated photo album. For example, the photo album creation component 150 could output the generated photo album for display, and could provide an interface through which the user can edit the photo album. Examples of such edits include adding a photograph to the album, removing a photograph from the album, reordering the photographs within the album, and so on. The photo album creation component 150 could then update a set of user preferences, based on the editorial actions taken using the interface, for use in generating subsequent photo albums. For example, the photo album creation component 150 could originally have selected a particular image for inclusion in the photo album at a particular position based on a determination that the selection matches a user's photo album preferences. However, if the user then uses the interface to remove the particular image from the photo album, the photo album creation component 150 could determine that the original determination was incorrect and could update the preference data for the user accordingly. Advantageously, doing so allows the photo album creation component 150 to learn the user's preferences for photograph selection and ordering.

Generally speaking, the photo album creation component 150 may be configured to select any number of photographs for inclusion in the photo album 330. For instance, the photo album creation component 150 could be configured to select a predefined number of photographs (e.g., 5 photographs, as shown in photo album 200). As another example, the photo album creation component 150 could determine a preferred number of photographs by analyzing the user-created photo albums 320_{1-N}, and could select the preferred number of photographs from the images 310_{1-N} for inclusion in the photo album 330. In smaller collections of images 310_{1-N}, the photo album creation component 150 could select all of the images 310_{1-N} for inclusion in the photo album 330, but could determine an optimal arrangement of the selected images within the photo album 330. With larger collections of images 310_{1-N}, however, the photo album creation component 150 may select only a subset of the images 310_{1-N} for inclusion in the photo album 330.

In one embodiment, the photo album creation component 150 may further determine a respective quality value for each of the images 310_{1-N}. The photo album creation component 150 could then use the determined quality values to remove at least one of the images 310_{1-N} from consideration for inclusion in the photo album 330. For example, a particular photograph could have been taken while the user was unintentionally moving the camera, and as a result the particular photograph could include a substantial amount of blur. In such an example, the photo album creation component 150 could assign a relatively low quality value to the particular photograph, and upon determining the low quality value does not satisfy a minimum quality threshold, could exclude the particular photograph from consideration for inclusion in the photo album 330.

Generally, the photo album creation component 150 may consider a variety of factors in determining the preferred photo album characteristics by analyzing the user-created photo albums 320_{1-N}. In one embodiment, the photo album creation component 150 is configured to construct a support vector machine (SVM) to process the photo albums 320_{1-N}, in order to learn preferred photograph selection characteristics and preferred photograph ordering characteristics within the plurality of photo albums. More generally, however, it is broadly contemplated that any machine-learning technique may be used by the photo album creation component 150, in modeling the preferred characteristics of a generated photo album.

For example, in one embodiment, the photo album creation component 150 can determine preferred photo selection characteristics based on digital photographs selected to appear within the plurality of photo albums, preferred photo ordering characteristics based on positions of digital photographs within the plurality of photo albums, and preferred image pairing characteristics based on sets of images appearing together with at least one of the plurality of photo albums. Here, the preferred photo selection characteristics could include characteristics of photographs that were selected for inclusion anywhere within the photo albums 320_{1-N}. As an example, the photo album creation component 150 could determine that no photograph below a certain minimum quality threshold was selected for inclusion in any of the user-created photo albums 320_{1-N}. The photo album creation component 150 could then use such a minimum quality threshold in selecting photographs from the images 310_{1-N}.

As another example, the photo album creation component 150 could consider image pairing characteristics within the user-created photo albums 320_{1-N}. Here, the photo album creation component 150 could consider whether certain groups of photographs frequently appeared together within individual photo albums from the user-created photo albums 320_{1-N}. As part of such a determination, the photo album creation component 150 could consider whether the group of photographs commonly appeared together in a particular order, or whether they commonly appeared together but in no particular order. The photo album creation component 150 could also determine attributes of the photographs within the group of photographs, and could use such attributes to determine whether a group of photographs within the images 310_{1-N} possess such attributes. If so, the photo album creation component 150 could select the group of photographs from the images 310_{1-N} for inclusion in the photo album 330.

In the depicted exemplary system 300, the user-created photo albums 320_{1-N} represent a positive set of examples. That is, the photo album creation component 150 is configured to consider the photo albums 320_{1-N} as positive examples of how a photo album should appear, and is configured to learn how to generate the photo album 330 based on these positive examples. In one embodiment, the photo album creation component 150 is configured to consider a second set of photo albums that represent negative examples (i.e., photo albums representative of how a photo album should not appear). In such an example, the photo album creation component 150 could consider the negative examples, in lieu of or in addition to the user-created photo albums 320_{1-N}, in generating the photo album 330. The use of such negative examples may assist the photo album creation component 150 in determining which attributes of photographs within the user-created photo albums 320_{1-N} are meaningful.

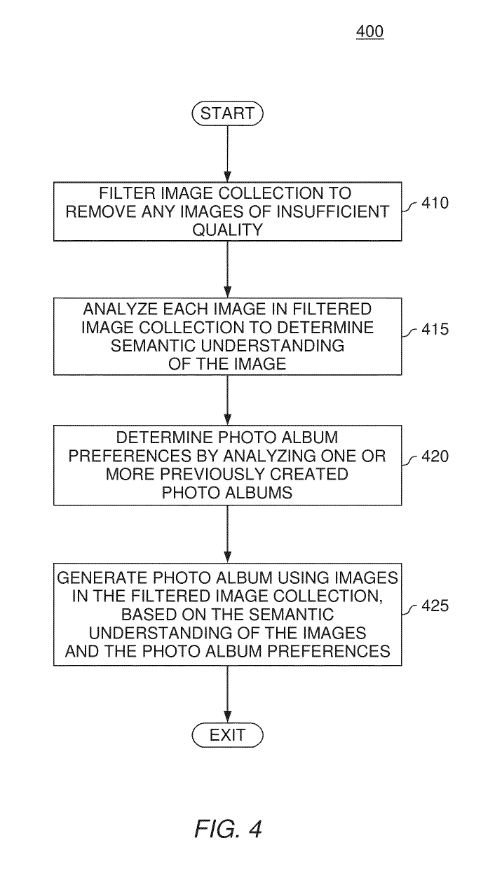

FIG. 4 is a flow diagram illustrating a method for generating a photo album, according to one embodiment described herein. As shown, the method 400 begins at block 410, where the photo album creation component 150 filters an image collection to remove any images of insufficient quality from consideration. For example, the photo album creation component 150 could compute a quality value for each image in the image collection, and could then remove from further consideration any images whose quality value does not satisfy a minimum threshold for quality.

The photo album creation component 150 then analyzes each image in the filtered image collection to determine a semantic understanding of the image (block 415). Such a semantic understanding generally represents some understanding of the contents of the image, such as (without limitation) whether any human faces appear within the image, landmarks appearing within the image, whether the image was taken during the day or during the night, whether the image was taken indoors or outdoors, and so on. More generally, however, it is broadly contemplated that the photo album creation component 150 may analyze the images in the filtered image collection to determine any characteristics of the images that could be used in selecting the images for inclusion in a photo album.

Additionally, the photo album creation component 150 determines photo album preferences by analyzing one or more previously created photo albums (block 420). For example, the photo album creation component 150 could determine a particular user's photo album preferences by analyzing photo albums previously created by the particular user. In one embodiment, the photo album creation component 150 is configured to determine a general set of photo album preferences by analyzing photo albums created by multiple different users. Such an embodiment may be preferable, for example, when the photo album creation component 150 is configured for use in a public location. For instance, the photo album creation component 150 could be installed in a kiosk (e.g., within a shopping center or store) and could be configured to generate photo albums for multiple different users. In such an embodiment, it may not be feasible for the photo album creation component 150 to tailor the generated photo album to the particular user's individual preferences, as previous photo albums generated by the particular user may not be available for the photo album creation component 150 to analyze. As such, the photo album creation component 150 may be configured with a general set of photo album preferences, based on an analysis of multiple photo albums created by multiple different users.

The photo album creation component 150 then generated a photo album using a subset of images in the filtered image collection, based on the semantic understanding of the images in the filtered image collection and further based on the determined photo album preferences (block 425). Once the photo album is generated, the method 400 ends. Upon generating the photo album, the photo album creation component 150 could be configured to save the photo album for future viewing (e.g., as a local file(s), as a file(s) on a storage medium such as flash memory, etc.). Additionally, the photo album creation component 150 could be configured to transmit the generated photo album (e.g., via an email message, to a remote web server, etc.).

In one embodiment, upon generating the photo album, the photo album creation component 150 may enable a user to make modifications to the generated photo album, in order to better suit the user's personal preferences. For example, the photo album creation component 150 could enable the user to re-order images within the photo album, to select a new image for inclusion in the photo album, to replace an image within the photo album with a new image, to remove an image in the photo album, etc. In such an example, the photo album creation component 150 could adjust the photo album preferences learned from analyzing the previously created photo albums, based on the user's modifications to the generated photo album, in order to improve the quality of subsequently generated photo albums. That is, the photo album creation component 150 may adjust its preference information (e.g., one or more weights corresponding to particular image attributes) in order to match the user's modifications to the generated photo album, in order to better satisfy the user's personal preferences with subsequently generated photo albums.

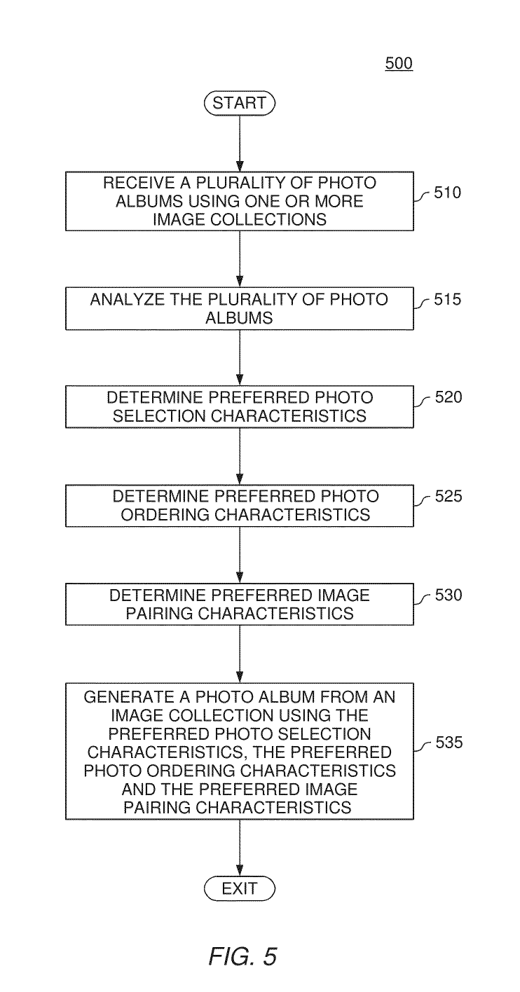

FIG. 5 is a flow diagram illustrating a method for generating a photo album, according to one embodiment described herein. As shown, the method 500 begins at block 510, where the photo album creation component 150 receives a plurality of photo albums created using one or more image collections. Generally, the photo album creation component 150 could use such photo albums as positive training data in learning how to generate a photo album according to a learned set of preferences. For instance, such photo albums could include a number of photo albums (e.g., 5 photo albums) generated from each of a plurality of image collections. Additionally, the photo albums may include annotations specifying aspects of individual photographs within the photo albums. For example, bounding boxes could be provided around important landmarks and costumed characters. Of note, while such data may be useful in training the photo album creation component 150, the photo album creation component 150 may generate a photo album from an unordered collection of photographs, without any preconfigured knowledge about the unordered collection of photographs or its contents.

The photo album creation component 150 may then begin analyzing the plurality of photo albums, in order to determine photo album preferences for use in generating subsequent photo albums (block 515). In analyzing the training set of photo albums, the photo album creation component 150 can determine preferred photo selection characteristics (block 520), preferred photo ordering characteristics (block 525) and preferred image pairing characteristics (block 530). The photo album creation component 150 then generated a photo album from an image collection using the determined characteristics (block 535), and the method 500 ends.

For example, given a new set of photos I, the photo album creation component 150 may select a subset of these photos A (encoded by the index vector y), which are arranged in the form of a photo album. For example, assume that the photo album creation component 150 is configured to generate a photo album containing 5 photographs. Here, an empty photo album may be said to have 5 empty frames, into which the photo album creation component 150 will insert optimal photographs to generate the photo album. In constructing such a photo album, the photo album creation component 150 may consider semantic relationships between frames within the photo album, as well as pairwise relationships such as correlations and exclusions between photographs in the unordered collection of photographs. The photo album creation component 150 may perform a training operation in which weights w are learned for a selection function (that may also implicitly order the selected photographs), encoded by the graphical model, f:X(I)→y that returns indices y of photos in the set I which maximize the score function F_{w} that operates on the feature representation of the frames X. Here, the structured output y defines a photo album, y={y₁, y₂, . . . , y_{M}}.

Generally, the photo album creation component 150 may be configured to use any algorithm or technique for generating the photo album. In one embodiment, photo album creation component 150 is configured to use the selection function shown in Equation 1 below.

$$\begin{matrix}Equation 1 - Selection Function & \\ \begin{matrix}{y}^{*} = f ( X ) \\ = arg {max}_{y ∈ y} {F}_{w} ( X , y )\end{matrix} & \end{matrix}$$

Additionally, the photo album creation component 150 may be configured with a score function F_{w}. An example of such a function is shown in equation 2, where the score function F_{w} factors into the sum of local and pairwise potentials, which measure the quality of the album y based on the photographs (and their order) in that album, as a function of the weight vector w=[wᵢ,wᵢⱼ]:

F_{w}(X,y)=wᵢ^{T}φᵢ(X,y)+wᵢⱼ^{Tl Ω}ᵢⱼ(X,y) Equation 2—Score Function

Here, wᵢ^{T}Φ(X,y)(the unary potential) measures how well a particular image X_{yi} fits the corresponding position iε[1,M] in the photo album, independent of other images in the album. In one embodiment, the photo album creation component 150 may be configured to assume that there is no independent preference between central or middle frames in the generated photo album. In such an embodiment, the photo album creation component 150 may still independently model preferences for the first frame (or the initial frame) and the last frame (or the final frame) of the photo album, as such frames may be semantic and different between each other and all other frames (i.e., the middle or central frames) of the photo album. As such, the unary potential in such an embodiment may be calculated using Equation 3 shown below, where three different terms are modeled (i.e., the initial frame, one or more middle frames, and the final frame).

$$\begin{matrix}Equation 3 - Unary Potential & \\ {w}_{i}^{T} Φ ( X , y ) = {w}_{f}^{T} {x}_{y 1} + {w}_{1}^{T} {x}_{y M} + {\sum }_{k = 2}^{M - 1} {w}_{m}^{T} {x}_{y k} & \end{matrix}$$

Here, X_{y1} describes the appearance of the photo which is selected as the first frame, x_{yM} describes the appearance of the photo selected as the last frame, and X_{yk} describes the appearance of the photo(s) selected as the middle frames.

Additionally, referring back to Equation 2, wᵢⱼ^{T}Ψᵢⱼ(X,y) (the pairwise potential) models different pairwiase contextual relationships between photo album frames. For instance, the photo album creation component 150 may be configured to learn inclusion and/or exclusion principles, with respect to the images selected to appear within photo albums. That is, given a selection for album frame i, what frame should (or should not) appear in place j. Additionally, the photo album creation component 150 may consider long-term correlations, such as the likely selection for the last frame in the photo album, given a particular selection for the first frame. For example, the pairwise potentials may be formulated by combining four different terms, as shown in Equation 4.

$$\begin{matrix}Equation 4 - Pairwise Potentials & \\ {w}_{ij}^{T} {Ψ}_{ij} ( X , y ) = {w}_{fl}^{T} ψ ( {x}_{y 1} , {x}_{{y}_{M}} ) + {\sum }_{k = 2} {w}_{fm}^{T} ψ ( {x}_{y 1} , {x}_{yk} ) + {\sum }_{k = 2}^{M - 1} {\sum }_{j = 2}^{M - 1} {w}_{m m}^{T} ψ ( {x}_{{y}_{k}} , {x}_{{y}_{j}} ) ı ( k \neq j ) + {\sum }_{k = 2}^{M - 1} {w}_{l m}^{T} ψ ( {x}_{{y}_{k}} , {x}_{{y}_{M}} ) , & ( 4 )\end{matrix}$$

In learning the weight vector w, the photo album creation component 150 could model the selection and arrangement of images for the photo album using structure SVM. However, for each image collection I, instead of having one true photo album, the photo album creation component 150 may be faced with A different labelings for possible albums from A different annotators (i.e., users who created and annotated the photo albums in the training set). The photo album creation component 150 may account for this by, for example, using the following slightly modified structural SVM formulation:

$$\begin{matrix}Equation 5 - SVM Formulation & \\ {min}_{ω , ξ \geq 0} \frac{1}{2} {\vert \vert w \vert \vert}^{2} + C {\sum }_{i = 1}^{S} {\sum }_{j = 1}^{A} {ξ}_{i , j} \\ s . t {F}_{w} ( {X}_{i} , {y}_{i , j} ) - {F}_{w} ( {X}_{i} , {y}_{i}^{*} ) \geq Δ ( {y}_{i , j} , {y}_{i}^{*} ) - {ξ}_{i , j} , \\ {y}^{*} ∈ y \backslash {y}_{i , j} , ∀ i , j . & \end{matrix}$$

In Equation 5, S refers to the number of different image collections in the training set, while A refers to the number of different ground truth albums that are provided for each collection. The structured output y contains the index of the photos selected for inclusion within the album. Additionally, y_{i,j} refers to the jth ground truth album of the ith collection, and y* refers to the highest scoring album selected by the inference rule shown in Equation 1.

Additionally, Δ in Equation 5 refers to the loss function. Here, since the score function F_{w} includes pairwise terms and the graph is fully connected, the photo album creation component 150 may not determine an exact maxima. Instead, the photo album creation component 150 may approximate the solution to the inference problem using the TRW-S method. Rather than a standard SVM which uses simple 0/1 loss functions, the photo album creation component 150 could incorporate a complex loss function which enables the photo album creation component 150 to penalize output albums based on how they deviate from the annotated concept of albums. Given that the training set may contain A different photo albums generated from each unordered image collection, there may be multiple correct solutions for generating a photo album based upon the training dataset. Additionally, these annotations may not be exhaustive in that typically other images exist in the photo collection that could be substituted for the ones selected by the annotators, without affect the quality or storytelling ability of the resulting photo album. For example, this may be due to a redundancy in photographs present within the image collection, which is a common phenomenon when dealing with dealing with photographs. Thus, the image collection may contain multiple pictures of identical content and nearly identical visual quality.

In order to handle these issues, the photo album creation component 150 may use a modified loss function, such as the loss function shown in Equation 6.

$$\begin{matrix}Equation 6 - Loss Function & \\ Δ ( {y}_{i , j} , {y}^{*} ) = 1 - {max}_{j} {Δ}_{sim} ( {y}_{i , j} , {y}^{*} ) , & \end{matrix}$$

In Equation 6, max accounts for multiple annotations and Δₛᵢₘ(y_{i,j}y*)ε[0,1] measures the semantic similarity between y_{i,j} and y*. The photo album creation component 150 may further decompose the similarity to one of the individually selected frames, for example, using the equation shown in Equation 7.

Δₛᵢₘ(y_{i,j},y*)=Σᵢ₌₁^{M}wᵢΔₛᵢₘ(yᵢ,yᵢ*) Equation 7—Semantic Similarity

Here, wᵢ represents the relative importance of the frame such that Σᵢwᵢ=1. In one embodiment, wᵢ is modeled as 1/M. Through the use of Equation 7, the photo album creation component 150 may model the loss as if it were a 0/1 loss model, where Δₛᵢₘ(yᵢ,yᵢ*)=1 if I_{yi} and I_{yi*} are semantically similar and Δₛᵢₘ(yᵢ, yᵢ*)=0 otherwise.Further, the photo album creation component 150 may compute similarity between images based on object annotations.

Additionally, in Equation 4, the pairwise feature φ(xᵢ,yⱼ) may take into account a variety of image descriptors that fall into three categories: facial features that encode presence/absence of faces and their spatial layout within a frame; global scene features that encode overall scene texture and color; and object features that encode presence/absence of landmarks. With respect to object features, certain landmarks and characters may highly influence the human preference for selecting frames in a photo album. In order to encode such features, the photo album creation component 150 may compute a feature vector for each image that reflects the presence/absence of any of the annotated landmarks and characters in a photo. For instance, the photo album creation component 150 could treat the most popular landmarks and/or characters that appear in the dataset as a bank of generic objects, and could use the bounding box annotations available in the training dataset (i.e., the previously created photo album analyzed by the photo album creation component 150) to train a bank of object detectors using a deformable part model.

For the global scene features, the photo album creation component 150 could use a number of common feature representations, such as: color histograms; locally-constrained linear coding (LLC) with SIFT; generic ObjectBank; self similarity (SSIM); local binary patterns (LBP); and texton histograms. Based on these features (or a sub-set of these features and/or other features), the photo album creation component 150 could build independent 1-vs-All SVM classifiers to classify an image as a first, middle or last frame. Additionally, the photo album creation component 150 could use a homogeneous kernel map of order 3 with x² kernels for SSIM and textons and combination of intersection and x² kernels for LBP and color histograms. Doing so could result in a 6-dimensional (i.e., one dimension for each feature type, in this example) response vector, for each classification task. The photo album creation component 150 could also train secondary level classifiers based on these responses to aggregate information across features. Doing so gives scores which can be interpreted as confidence of a given frame being suited for the first frame, the last frame or one of the middle frames of the photo album, based on all available scene features.

With regard to the facial features, the photo album creation component 150 could detect all faces in each image being considered for inclusion in the photo album using a face detection algorithm (e.g., a Fraunhofer face detector). Based on these detections, the photo album creation component 150 could compute spatial layout features that contain certain aspects of proxemics. For instance, where the face detector returns a bounding box containing a detected face and eyes, the photo album creation component 150 could compute: a histogram of face area representing a fraction of the normalized image area occupied by a face detection; a histogram of face overlap representing an overlap of two faces A and B using the measures

$$\frac{A ⋂ B}{A ⋃ B} and \frac{A ⋂ B}{A} ;$$

a histogram of pairwise face distances representing pairwise distances between centroids of all detected faces; a histogram of distances to face centroid representing a distance of each detected face from the centroids of all the detections in an image; a histogram of facial orientations that approximates an orientation of each face by the angle of the line connecting the two eyes to the horizontal; and a histogram of the node degree in the minimum spanning tree graph. This results in a concatenated feature vector of dimension 102. Here, the photo album creation component 150 could train a 1-vs-All SVM with an intersection kernel to classify photos into the first, middle and last frames of the photo album being generated.

For unary features, the photo album creation component 150 may concatenate all feature types to form xᵢ=[xᵢ^{(face)}, xᵢ^{(glob)}, xᵢ^{(obj)}]. Additionally, the photo album creation component 150 may determine the pairwise feature to be a combination of a feature-wise dot product of global scene features and the absolute difference between object detection scores |xᵢ^{(obj)}−xⱼ^{(obj)}|. For instance, the pairwise feature could be modeled as φ(xᵢ,xⱼ)ε [symbol] ²⁶⁺⁶.

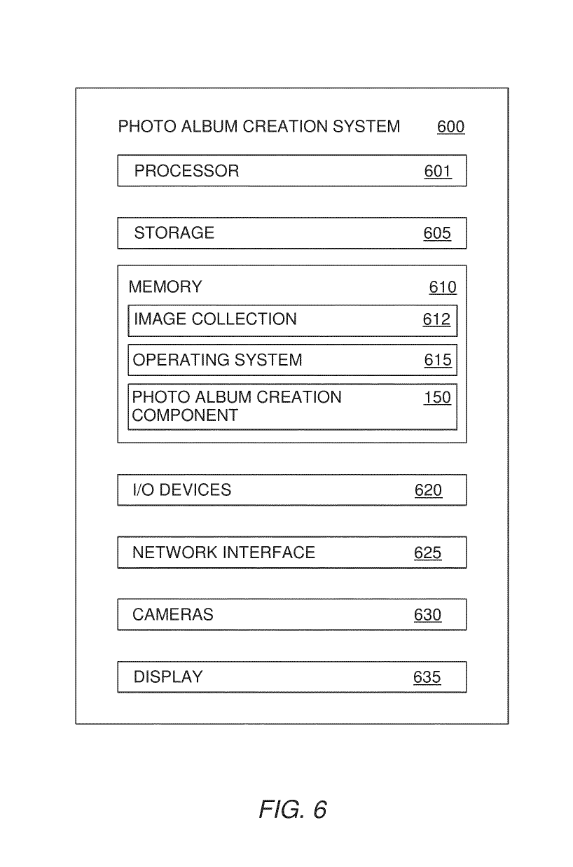

FIG. 6 is a block diagram illustrating a system configured with a photo album creation component, according to one embodiment described herein. In this example, the photo album creation system 600 includes, without limitation, a processor 602, storage 605, memory 610, I/O devices 620, a network interface 625, camera devices 630, and a display device(s) 635. Generally, the processor 602 retrieves and executes programming instructions stored in the memory 610. Processor 602 is included to be representative of a single CPU, multiple CPUs, a single CPU having multiple processing cores, GPUs having multiple execution paths, and the like. The memory 610 is generally included to be representative of a random access memory. The network interface 625 enables the photo album creation component 150 to connect to a data communications network (e.g., wired Ethernet connection or an 802.11 wireless network). Further, while the depicted embodiment illustrates the components of a photo album creation system 600, one of ordinary skill in the art will recognize that embodiments may use a variety of different hardware architectures. In one embodiment, the photo album creation system 600 is configured for use with a projection system display device 635 comprising one or more projection devices. Such a projection system display device 635 could be used for displaying one or more generated photo albums. Moreover, it is explicitly contemplated that embodiments of the invention may be implemented using any device or computer system capable of performing the functions described herein.

The memory 610 represents any memory sufficiently large to hold the necessary programs and data structures. Memory 610 could be one or a combination of memory devices, including Random Access Memory, nonvolatile or backup memory (e.g., programmable or Flash memories, read-only memories, etc.). In addition, memory 610 and storage 605 may be considered to include memory physically located elsewhere; for example, on another computer communicatively coupled to the photo album creation system 600. Illustratively, the memory 610 includes a photo album creation component 150 and an operating system 615. The operating system 615 generally controls the execution of application programs on the photo album creation system 600. Examples of operating system 615 include UNIX, a version of the Microsoft Windows® operating system, and distributions of the Linux® operating system. Additional examples of operating system 615 include custom operating systems for gaming consoles, including the custom operating systems for systems such as the Nintendo DS® and Sony PSP®.

The I/O devices 620 represent a wide variety of input and output devices, including displays, keyboards, touch screens, and so on. For instance, the I/O devices 620 may include a display device used to provide a user interface. As an example, the display may provide a touch sensitive surface allowing the user to select different applications and options within an application (e.g., to select an instance of digital media content to view). Additionally, the I/O devices 620 may include a set of buttons, switches or other physical device mechanisms for controlling the coloration adjustment system 600. For example, the I/O devices 620 could include a set of directional buttons used to control aspects of a video game played using the photo album creation system 600.

As discussed above, the photo album creation component 150 is generally configured to generate a photo album from an unordered collection of photographs. For instance, the photo album creation component 150 could analyze a plurality of photo albums to determine photo album characteristics, where each of the plurality of photo albums comprises a respective plurality of digital photographs arranged in a respective order. Here, the plurality of photo albums relate to one or more unordered collections of digital photographs. Additionally, the photo album creation component 150 could process an unordered digital photograph collection to determine characteristics of each digital photograph within the digital photograph collection. The photo album creation component 150 could then generate a photo album using digital photographs from the digital photograph collection, based on the determined photograph album characteristics, where the generated photo album comprises a second plurality of digital photographs arranged in a determined order.

In the preceding, reference is made to various embodiments. However, the present disclosure is not limited to specific described embodiments. Instead, any combination of the preceding features and elements, whether related to different embodiments or not, is contemplated to implement and practice the invention. Furthermore, although particular embodiments may achieve advantages over other possible solutions and/or over the prior art, whether or not a particular advantage is achieved by a given embodiment is not limiting within the context of this disclosure. Thus, the preceding aspects, features, embodiments and advantages are merely illustrative and are not considered elements or limitations of the appended claims except where explicitly recited in a claim(s). Likewise, any reference to “the invention” shall not be construed as a generalization of any inventive subject matter disclosed herein and shall not be considered to be an element or limitation of the appended claims except where explicitly recited in a claim(s).

Aspects of the present disclosure may be embodied as a system, method or computer program product. Accordingly, such aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user could access a photo album creation component 150 available in the cloud in order to generate a photo album from an unordered collection of photographs. For example, a photo album creation component 150 could execute on node within the cloud and could analyze a plurality of photo albums within the cloud in order to determine photo album preferences. The photo album creation component 150 could also analyze photographs within an unordered collection of photographs to determine attributes of the photographs. The photo album creation component 150 could then generate a photo album by selecting photographs from the unordered collection of photographs and by arranging the selected photographs in a particular order, based upon the determined photo album preferences. Doing so allows a user to generate a photo album from any device or computer system attached to a network connected to the cloud (e.g., the Internet).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special-purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method, comprising:
analyzing a plurality of photo albums to determine photo album characteristics, wherein each of the plurality of photo albums comprises a respective plurality of digital photographs arranged in a respective order, and wherein the plurality of photo albums relate to one or more digital photograph collections;
processing a digital photograph collection, by operation of one or more computer processors, to determine characteristics of each digital photograph within the digital photograph collection; and
generating a photo album using digital photographs from the digital photograph collection, based on the determined photograph album characteristics, wherein the generated photo album comprises a second plurality of digital photographs arranged in a determined order.

2. The method of claim 1, wherein generating the photo album further comprises:
selecting a first digital photograph from the digital photograph collection to insert into an initial position within the photo album, based on characteristics of digital photographs in the initial position across the plurality of photo albums;
selecting a second digital photograph from the digital photograph collection to insert into a final position within the photo album, based on characteristics of digital photographs in the final position across the plurality of photo albums; and
selecting two or more digital photographs from the digital photograph collection to insert into central positions within the photo album, based on characteristics of digital photographs in central positions across the plurality of photo albums.

3. The method of claim 1, further comprising:
for each digital photograph within the digital photograph collection, determining a respective quality value for the image; and
filtering at least one of the digital photographs out of the digital photograph collection, based upon the determined quality values.

4. The method of claim 1, wherein at least one digital photograph within the digital photograph collection is not selected for inclusion in the generated photo album.

5. The method of claim 1, wherein analyzing a plurality of photo albums to determine photo album characteristics further comprises:
determining preferred photo selection characteristics based on digital photographs selected to appear within the plurality of photo albums;
determining preferred photo ordering characteristics based on positions of digital photographs within the plurality of photo albums; and
determining preferred image pairing characteristics based on sets of images appearing together with at least one of the plurality of photo albums.

6. The method of claim 1, wherein the plurality of photo albums were created by one or more users performing an operation comprising, for each of the plurality of photo albums:
selecting digital photographs from the one or more digital photograph collections; and
arranging the selected digital photographs within the respective photo album in the respective order.

7. The method of claim 1, wherein the plurality of photo albums represent positive examples of photo albums, and wherein analyzing a plurality of photo albums to determine photo album characteristics further comprises:
configuring at least one of (i) a support vector machine (SVM) and (ii) a Hidden Markov Model, to process the plurality of photo albums in order to learn preferred photograph selection characteristics and preferred photograph ordering characteristics within the plurality of photo albums.

8. The method of claim 7, further comprising:
analyzing a second plurality of photo albums to determine unpreferred photograph selection characteristics and unpreferred photograph ordering characteristics within the second plurality of photo albums,
wherein the second plurality of photo albums represent negative examples of photo albums.

9. The method of claim 1, wherein generating the photo album using digital photographs from the digital photograph collection further comprises, for each of the digital photographs in the digital photograph collection:
determining a measure of quality for the digital photograph; and
calculating a measure of suitability for inclusion of the digital photograph in the photo album, based at least in part on the determined measure of quality.

10. The method of claim 1, wherein generating the photo album using digital photographs from the digital photograph collection further comprises:
determining at least one of a selection and an ordering of digital photographs for inclusion in the photo album, such that the resulting photo album summarizes the digital photograph collection.

11. The method of claim 1, wherein generating the photo album using digital photographs from the digital photograph collection further comprises:
determining at least one of a selection and an ordering of digital photographs for inclusion in the photo album, such that the resulting photo album describes a determined storyline, wherein the plurality of photo albums correspond to the determined storyline, and wherein the determined storyline includes at least one of a location, an event, a time, an excitement level, a plot, a theme, and a character development.

12. The method of claim 1, wherein generating the photo album using digital photographs from the digital photograph collection further comprises:
determining at least one of a selection and an ordering of digital photographs for inclusion in the photo album, based on metadata associated with digital photographs, the metadata including at least one of global positioning system (GPS) data, time and date information, and one or more camera parameters.

13. The method of claim 1, wherein generating the photo album using digital photographs from the digital photograph collection further comprises:
generating a plurality of photo albums using digital photographs from the digital photograph collection, based on the determined photograph album characteristics, wherein each of the plurality of photo albums comprises a respective plurality of digital photographs arranged in a respective order;
outputting the plurality of photo albums for display; and
receiving a selection of one of the generated plurality of photo albums.

14. The method of claim 1, further comprising:
outputting the generated photo album for display;
providing an interface for editing the generated photo album, including at least re-ordering the digital photographs within the photo album and altering a selection of the digital photographs within the photo album; and
altering the determined album characteristics for use in generating subsequent photo albums, based on one or more editorial actions taken using the provided interface.

15. The method of claim 1, wherein the determined characteristics include at least one of scenery, one or more objects, one or more people, a configuration of elements, a measure of quality, a composition and content within at least one of the digital photographs within the digital image collection.

16. The method of claim 1, wherein generating the photo album using digital photographs from the digital photograph collection further comprises:
organizing the digital photograph collection into a plurality of clusters, wherein each of the clusters includes one or more digital photographs having a common characteristic;
generating an ordered selection of a subset of the plurality of clusters, for inclusion in the photo album, based on the determined photograph album characteristics; and
for each of the subset of clusters, selecting a respective highest quality photograph from within the cluster,
wherein the generated photo album comprises the selected highest quality photographs from each of the clusters, arranged in the ordering of the ordered selection.

17. The method of claim 1, wherein each of the plurality of photo albums includes a measure of desirability, and wherein analyzing a plurality of photo albums to determine photo album characteristics further comprises:
determining a measure of desirability for each of the determined photo album characteristics, based on the measure of desirability for a corresponding one or more of the plurality of photo albums.

18. The method of claim 17, wherein analyzing a plurality of photo albums to determine photo album characteristics further comprises:
providing an interface to display at least one of the plurality of photo albums; and receiving the measure of desirability for the displayed at least one photo album using the provided interface.

19. A non-transitory computer-readable medium containing computer program code that, when executed by operation of one or more computer processors, performs an operation comprising:
analyzing a plurality of photo albums to determine photo album characteristics, wherein each of the plurality of photo albums comprises a respective plurality of digital photographs arranged in a respective order, and wherein the plurality of photo albums relate to one or more digital photograph collections;
processing a digital photograph collection to determine characteristics of each digital photograph within the digital photograph collection; and
generating a photo album using digital photographs from the digital photograph collection, based on the determined photograph album characteristics, wherein the generated photo album comprises a second plurality of digital photographs arranged in a determined order.

20. A system, comprising:
a processor; and
a memory containing computer program code that, when executed by operation of the processor, performs an operation comprising:
analyzing a plurality of photo albums to determine photo album characteristics, wherein each of the plurality of photo albums comprises a respective plurality of digital photographs arranged in a respective order, and wherein the plurality of photo albums relate to one or more digital photograph collections;
processing a digital photograph collection to determine characteristics of each digital photograph within the digital photograph collection; and
generating a photo album using digital photographs from the digital photograph collection, based on the determined photograph album characteristics, wherein the generated photo album comprises a second plurality of digital photographs arranged in a determined order.
